(19) United States
(12) Patent Application Publication
(10) Pub. No.: US 2011/0291953 A1
(43) Pub. Date: Dec. 1, 2011

(54) ROBOT DEVICE AND PLATFORM FOR SOCIAL NETWORKING

(75) Inventors: Adrian David Cheok, Singapore (SG); Owen Noel Newton Fernando, Singapore (SG)

(73) Assignee: National University of Singapore, Singapore (SG)

(21) Appl. No.: 12/790,879

(22) Filed: May 31, 2010

(51) Int. Cl. G06F 15/16; G06F 3/041

(52) U.S. Cl. 345/173; 709/204; 709/229

(57) ABSTRACT

A small microcontroller based robotic toy includes various rich features on its small footprint. User input sensing includes a smooth scrolling enabled resistive or capacitive touch sensing pad primarily for child-friendly menu navigation. Pressure activated squeeze areas of the robot surface facilitate exchange of special gifts and emoticons through a network. Additionally, the robotic toy allows a user to experience a multimodal engagement visually via a miniature OLED graphics display, audibly by an embedded audio system for producing sounds and through haptics using a vibrotactile effects generator.

### BACKGROUND

This invention relates generally to social networking, and more particularly to a microcontroller device allowing use of physical proximity when performing actions within a social network.

Social networking systems have become prevalent in recent years because they provide a useful environment in which users can connect to and communicate with other users. Although a variety of different types of social networking systems exist, these systems commonly provide mechanisms allowing users to define and interact within their social networks. Through a social network, users may keep in touch with current friends, reconnect with old friends or create new friendships through similar interests or groups identified by the social network. In addition to facilitating social relationships, these features also allow a social network to be used as an educational tool.

The increasing prominence of social networks have made them more available to younger children, allowing children to more frequently interact with their friends and to more readily form new friendships. However, the increased use and availability of social networks has also made social networks an environment where children may be more readily victimized. For example, social networks have made it significantly easier for unknown people to interact with children. With limited ability to verify the identity of users interacting with children via a social network, there is an increased risk of a child becoming involved in an exploitative online relationship. Thus, the competing benefits and risks of social networks often result in conflicting message between parents and children regarding use of social networks. Further, the potential dangers of social network use may even cause a feeling of social isolation in some children. Accordingly, a mechanism for obtaining additional information about social network users seeking to interact with other members is needed to provide more secure connections between social network users.

### SUMMARY

Embodiments of the invention provide a system for performing an action using a social network. For example, the system allows two users of a social network to establish a connection between each other or to exchange data with each other. The system includes a first social networking device and a second social networking device. After receiving an input associated with an action, the first social networking device determines whether the first social networking device is physically proximate to the first social networking device. For example, after receiving a request to generate a connection with a user of the second social networking device, the first social networking device determines whether a surface of the first social networking device contacts a surface of the second social networking device. In an alternative configuration, after receiving a request to send data to a user of the second social networking device, the first social networking device determines whether the second social networking device is within a specified distance of the first social networking device. If the second social networking device is physically proximate to the first social networking device, the first social networking device receives from the second social networking device an identifier associated with the second social networking device. For example, the first social networking device receives a 64-bit identification key uniquely identifying the second social networking device. The first social networking device then transmits an action request including the identifier associated with the second social networking device, an identifier associated with the first social networking device and a description of the action to a social networking system.

Upon receiving the action request, the social networking system determines social networking users associated with the first identifier and the second identifier. For example, the social networking system identifies a first user associated with the first identifier and a second user associated with the second identifier. Based on data associated with the second user, the social networking system determines whether to authenticate the requested action. For example, the social networking system presents data associated with the first user, data associated with the second user and a description of the action to a third-party which determines whether to permit the action based on the data associated with the first and/or second users. If the action is authenticated, the social networking system performs the action; however, if the action is not authenticated the social networking system takes no action and the action request can be deleted. In one embodiment, the action request is automatically deleted. In an alternative embodiment, the action request remains stored until an input to authenticate or to remove the action request is received from the third party. Thus, the system increases the security of social networking connections by requiring physical proximity between social networking devices before allowing an action to be performed and by enabling a third-party to review potential actions on a social networking to ensure the actions are desirable or that the actions do not involve a potentially unsavory user before executing the action.

A social networking device includes an input device that receives an input identifying an action and a location determination device configured to determine the location of the social networking device relative to additional social networking devices. For example, the input device may be a capacitive or resistive touch screen and the location determination device may be a radiofrequency identification (RFID) tag. In one embodiment, the social networking device also includes one or more pressure activated switches which generate data identifying an action when depressed. Additionally, the social networking device includes one or more output devices for providing feedback to a user. For example, the social networking device may include a display device, an audio system and a vibrotactile generator to provide a user with visual, auditory and haptic feedback, enhancing user interaction with the social networking device. The social networking device may also have a form factor appealing to children to increase the likelihood of children using the social networking device. For example, the social networking device has one or more furry surfaces and a compact, rounded shape to appear more inviting to children.

### BRIEF DESCRIPTION OF THE DRAWINGS

FIG. 1 is a high-level block diagram of a system for providing data to a social network using one or more devices in accordance with an embodiment of the invention.

FIG. 2 is a high-level block diagram of a social networking device for communicating data to a social network in accordance with an embodiment of the invention.

FIG. 3 is an event diagram of a method for performing an action via a social network using social networking devices in accordance with an embodiment of the invention.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture for Distribution of Data Using a Social Networking System

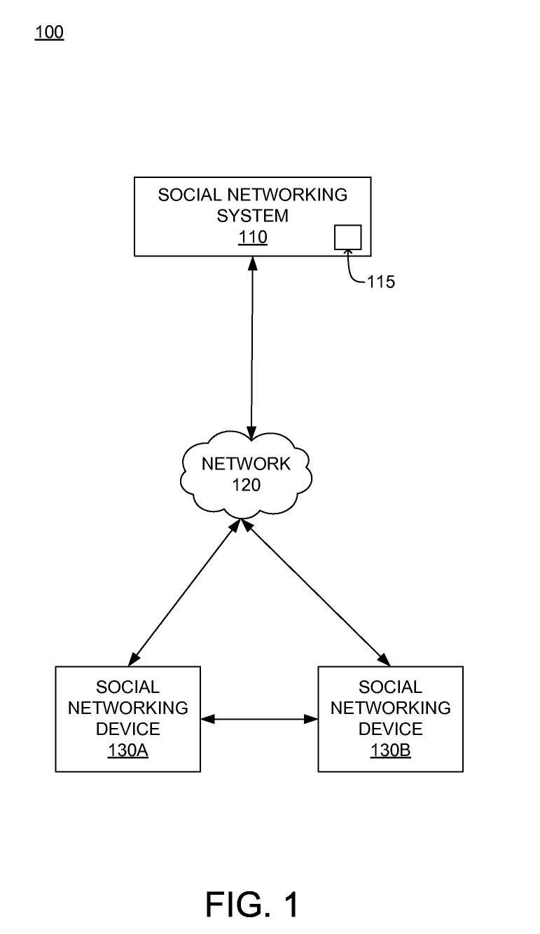

FIG. 1 is a network diagram of one embodiment of a system 100 to provide data to social network users via one or more social networking devices 130. The system 100 includes a social networking system 110 and one or more social networking devices 130 coupled to the social networking system 110 through a network 120, which may comprise any combination of local area and/or wide area networks, using both wired and wireless communication systems. For purposes of illustration, the embodiment of the system 100 shown by FIG. 1 includes two social networking devices 130A, 130B; however, in other embodiments, the system 100 may include more social networking devices 130. The social networking system 110 provides a platform, or backbone, for providing data or services to various users of the social networking devices 130 using the network 120.

The social networking system 110 comprises one or more computing devices storing a social network comprising a plurality of users and providing users of the social network with the ability to communicate and interact with other users of the social network. The social networking system 110 stores profile information describing each user, such as demographic or contact information associated with the user or any other data associated with a user. In use, users join the social networking system 110 and then add connections to a number of other users of the social networking system 110 to whom they desire to be connected. As used herein, the term “friend” refers to any other user of the social networking system 110 to whom a user has formed a connection, association, or relationship via the social networking system 110.

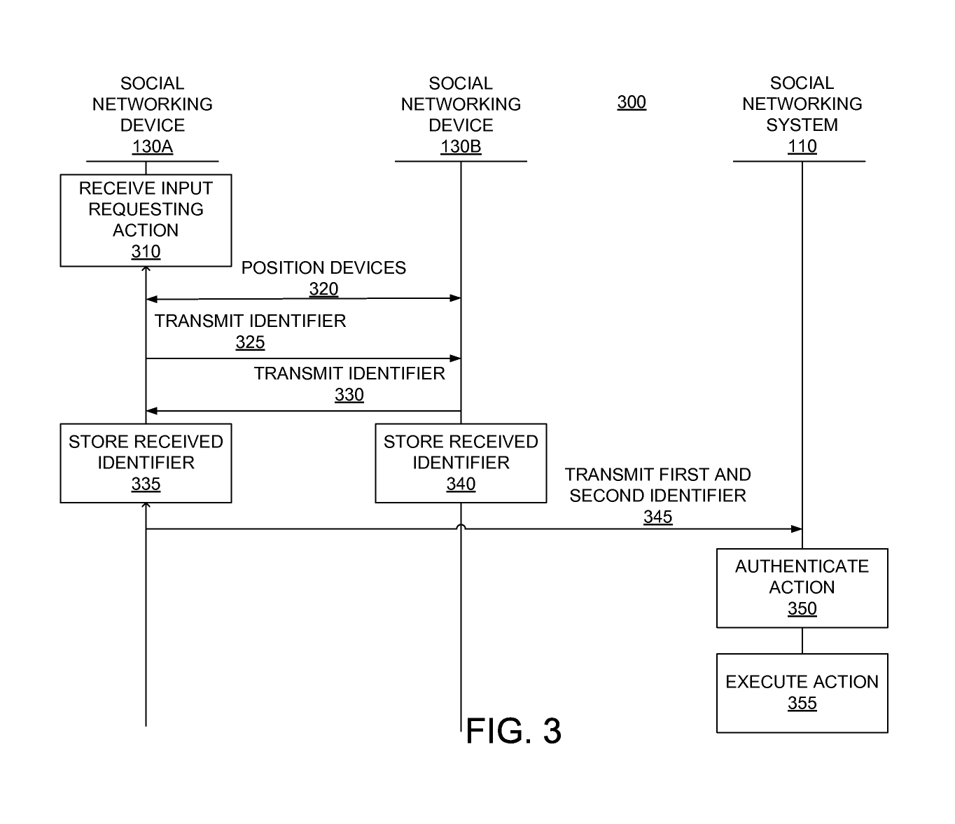

As further described below in conjunction with FIG. 3, connections between users are generated by physical interaction between social networking devices 130A, 130B associated with different users. For example, to become friends with a second user, after requesting a connection with the second user, a social networking device 130A associated with the first user is positioned in physically proximate to a social networking device 130B associated with the second user. The social networking system 110 then receives an action request including a first identifier associated with the first social networking device 130A, a second identifier associated with the second social networking device 130B and a request to generate a connection between the first user and the second user. Using stored data associating users with social networking devices 130, the social networking system 110 identifies a first user and a second user associated with the first identifier and the second identifier, respectively. For example, the social networking system 110 includes a database associating a user name with a key identifying a social networking device 110, allowing a social networking device 130 to be uniquely associated with a user of the social networking system 110. Hence, data received from a social networking device 110 may be associated with a corresponding social network user.

In one embodiment, the social networking system 110 includes an authentication system 115 allowing a third-party to determine whether or not the social networking system 110 performs an action identified by an action request. For example, the authentication system 115 allows a third-party to review data associated with users identified by the identifiers included in an action request to obtain information about the users used to determine whether the social networking system 110 performs the action. For example, the authentication system 115 presents to the third-party information stored in profiles associated with users identified by an action request, allowing a third party to review potential connections between users. If the authentication system 115 authenticates the action the social networking system 110 executed the action, such as generating a connection between the pair of users. In one embodiment, the authentication system 115 receives an input from the third-party authenticating the action. If the authentication system 115 does not authenticate an action identified by an action request, no action is taken and the action request can be deleted. For example, a social networking device 130A is used by a child and the authentication system 115 generates a listing of potential connections between the child and other users associated with other social networking devices 130B; the child's parents review the listing of potential connections and provide input to the authentication system 115 to regulate whether a connection is established between the child and another user. Receiving input from the parents before establishing a connection allows the authentication system 115 to prevent establishment of a connection between the child and another user that appears undesirable or dangers to the child's parents. Hence, the authentication module 115 increases the security of a connection, or other action, between social network users by allowing a third party to verify the desirability of the connection, or other action.

Connections in the social networking system 130 are usually in both directions, but need not be, so the terms “user” and “friend” depend on the frame of reference. Connections between users of the social networking system 130 are usually bilateral, or “mutual,” but connections may also be unilateral, or “one-way.” For example, if Bob and Chris are both users of the social networking system 110 and connected to each other, Bob and Chris are each other's connections. If, on the other hand, Bob wishes to connect to Chris to view data communicated to the social networking system by Chris but Chris does not wish to form a mutual connection, a unilateral connection may be established. The connection between users may be a direct connection; however, some embodiments of a social networking system allow the connection to be indirect via one or more levels of connections or degrees or separation.

In addition to establishing and maintaining connections between users and allowing interactions between users, the social networking system 110 provides users with the ability to take actions on various types of items supported by the social networking system 110. These items may include groups or networks (where “networks” here refer not to physical communication networks, but rather social networks of people or entities) to which users of the social networking system may belong, events or calendar entries in which a user might be interested, computer-based applications that a user may use via the social networking system 110, transactions that allow users to buy or sell items via the service, and interactions with advertisements that a user may perform on or off the social networking system. These are just a few examples of the items upon which a user may act on a social networking system, and many others are possible. A user may interact with anything that is capable of being represented in the social networking system 110 via a network 120.

The social networking system 110 also includes user-generated content, which enhances a user's interactions with the social networking system 110. User-generated content may include anything a user can add, upload, send, or otherwise communicate to the social networking system 110. For example, a user communicates data to the social networking system 110 from a social networking device 130. Data may include textual data, photos, videos, links, music, graphics, gifts, emoticons which provide a visual indication of a user's emotional state or other similar data and/or media. In this way, users of the social networking system 110 are encouraged to communicate with each other by communicating various types of data to other users via the social networking system 110 and the network 120.

In one embodiment, the social networking system 110 also generates a visual representation of a social network, allowing social network users to view visual representations of their friends or of actions taken by their friends. For example, the social networking system 110 generates a three-dimensional virtual world where a user is represented by an avatar or similar graphical representation. The graphical representation may use imaging tailored to children, such as cartoon images, images based on the Japanese “Kawaii” culture or other cute and/or child-friendly images. In one embodiment, actions performed using the social networking device 130 are visually depicted by movement of the avatar in the virtual world. For example, if one or more pressure sensors on a social networking device 130 are contacted by a user, an avatar associated with the social networking device 130 is manipulated to perform a particular action, such as hugging an avatar associated with a second user.

Further, the social networking system 110 may provide a visual representation of the relationship between different users. For example, the social networking system 110 generates a display where an image associated with a first user is centered and images representing various friends connected to the first user are displayed in concentric rings around the image associated with the first user. In one embodiment, friends having the largest friendship strength with the first user are displayed in the ring nearest to the first user and friends having lower friendship strengths with the first user are displayed in rings farther from the first user. In one embodiment, the friendship strength between users is determined by the number of interactions between a friend and the first user and/or the date of the most recent interactions between a friend and the first user; however, in other embodiments, other criteria may be used to determine the friendship strength between users.

A social networking device 130 comprises a processor-based device configured to receive input from a user and to transmit and receive data via the network 120, which may comprise any combination of local area and/or wide area networks, using both wired and wireless communication systems. In one embodiment, the social networking device 130 comprises a small robotic toy including a processor, a transceiver, one or more input devices and one or more output devices. A social networking device 130A is configured to exchange data with the social networking system 110 or with another social networking device 130B via the network 120 and is also configured to directly exchange data with another social networking device 130B using a communication channel between social networking devices 130A, 130B. Additionally, each social networking device 130 includes a storage device storing a unique identifier, such as an identification key or serial number, associated with the social networking device 130. This unique identifier is also stored by the social networking system 110 and associated with a user, as described above, so that the social networking system 110 is able to identify a user from a unique identifier and vice versa.

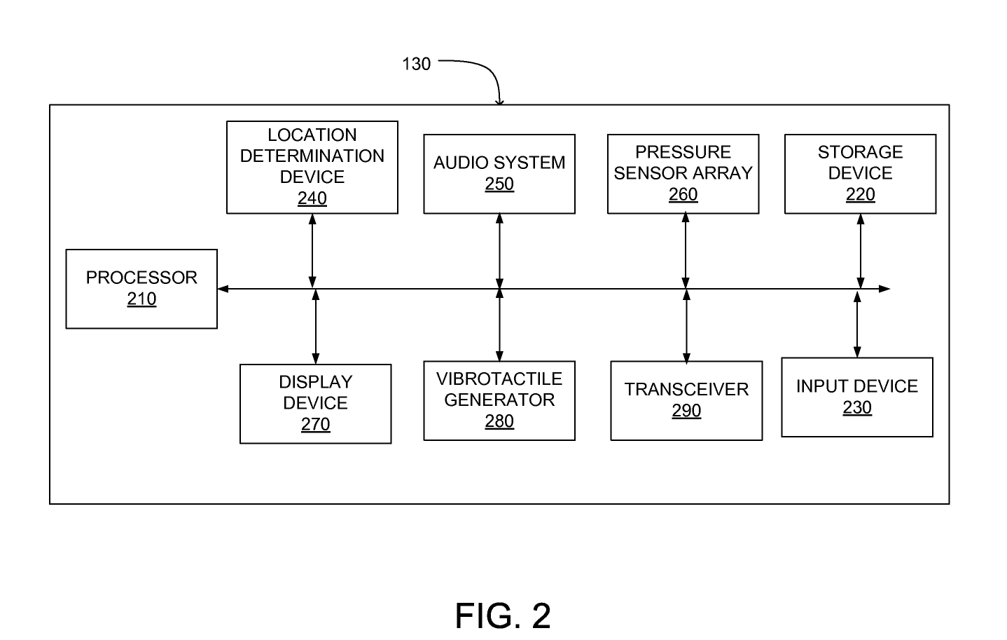

In one embodiment, a social networking device 130 is designed so that its size, texture and shape are suited for use by children in a particular age range. For example, the social networking device 130 has a furry or soft surface, a rounded physical shape and a compact size to facilitate use by children ages 7 to 9. Additionally, one or more user interfaces, such as visual displays, audio playback system or vibrational feedback systems are designed to simplify data receipt or data entry by children. The social networking device 130 may also use visual interfaces designed to facilitate use by children. For example, visual interfaces may use cutely designed images or phrases to simplify use of the social networking device 130 by children. A social networking device 130 is further described below in conjunction with FIG. 2.

FIG. 2 is a high-level block diagram of one embodiment of a social networking device 130. In the embodiment shown by FIG. 2, the social networking device 130 includes a processor 210, a storage device 220, one or more input devices 230, a display device 270, a transceiver 280 and a location determination device 240 coupled by a bus. As shown in FIG. 2, the social networking device 130 may also include one or more of an audio system 250, a pressure sensor array 260 and/or a vibrotactile generator 290 coupled to the processor 210 by the bus. It should be understood, however, that not all of the above components are required for the social networking device 130, and this is not an exhaustive list of components for all embodiments of the social networking device 130 or of all possible variations of the above components. A social networking device 130 may have any combination of fewer than all of the capabilities and components described in conjunction with FIG. 2.

The social networking device 130 allows a user to provide input to the social networking system 110 using a variety of mechanisms and also allow the social networking device 130 to provide feedback based on data received from the social networking system 110, or from another social networking device 130, using a variety of techniques, allowing a user to receive multimodal feedback using various methods. For example, the display device 270, audio system 250 and vibrotactile generator 290 allow a social networking device 130 to provide visual, auditory and haptic feedback to a user based on data received from the social networking system 110 or from another social networking device 130 or responsive to input received by the social networking device 130.

The processor 210 and storage device 220 allow the social networking device 130 to perform data processing and data storage. The processor 210 is coupled to the storage device 220, the input device 230, the display device 270 and other components included in the social networking device 130 through a bus to allow applications running on the social networking device 130 to use the various components.

In various embodiments, the storage device 220 comprises random access memory (RAM), flash memory or other persistent memory or a combination of RAM and persistent memory. As a result, executable applications can be stored and executed on the social networking device 130 and data can be stored by the social networking device 130. The social networking device 130 may store data in the storage device 220 either indefinitely, until the data is communicated from the social networking device to the social networking system 110 or until another event occurs. A unique identifier associated with the social networking device 130 is stored in the storage device 220. For example, the storage device 220 includes a 64- or 80-bit identification key uniquely identifying the social networking device 130. The storage device 220 also stores data describing interactions between the social networking device 130 and the social networking system 110 or between social networking devices 130. For example, the storage device 220 stores an identifier associated with a second social networking device 130 and data describing an interaction between the social networking device 130 and the second social networking device 130.

In an embodiment, the social networking device 130 also includes in the storage device 220 an operating system or other software supporting one or more input modalities, such audio capture, gesture capture or other input capture, and/or one or more output modalities, such as audio playback, display of visual data or generation of haptic feedback. The operating system or other software may support a combination of input modalities and output modalities and manages the combination, sequencing and transitioning between input modalities (e.g., capturing gesture data or interactions with buttons or other input devices as input) and output modalities (e.g., presenting audio, visual or haptic data as output to a user). The operating system may use simple graphics for visual output and receive input by capturing simple gestures to make the social networking device 130 child-friendly. For example, input may be received by touching an input device 230, by depressing a pressure sensitive switch or moving the social networking device 130, allowing capture of data in ways that mirror interactions between humans.

The input device 230 receives input from a user through one or more user interactions with the input device 230. In one embodiment, the input device 230 comprises a capacitive touch sensing pad capturing data based on the position of an object relative to the touch sensing pad or a resistive touch sensing pad. In one embodiment, the input device 230 may also include one or more buttons where input is received when a user depresses or contacts a button. In other configurations the input device 230 may comprise any device suitable for capturing data from a user. Data received by the input device 230 determines an action performed by the social networking device 130, such as requesting a connection to a different social networking device 130, transmitting data to a different social networking device 130 or to the social networking system 110 or presenting data received from a different social networking device 130 or from the social networking system 110. In one embodiment the input device 230 is configured to simplify acquisition of data from a user to make it easier for children to provide input to the social networking device 130.

The location determination device 240 is a device capable of determining a location of the social networking device 130 with respect to other social networking devices 130. In one embodiment, the location determination device 240 includes a radio frequency identification (RFID) tag and an RFID receiver. The RFID tag transmits the unique identifier associated with the social networking device 130 upon receiving electromagnetic energy from an RFID receiver. Similarly, the RFID receiver receives data, such as an identifier associated with another social networking device 130, from another RFID tag. This allows the location determination device 240 to exchange device identifiers, or other data, with social networking devices 130 within a specified distance from the social networking device 130. For example, when a first social networking device 130A and a second social networking device 130B are within a specified distance of each other, the location determination device 240 in the first social networking device 130A transmits an identifier associated with the first social networking device 130A and receives an identifier associated with the second social networking device 130B.

In an embodiment, the location determination device 240 may also include a global positioning system (GPS) module 270 that determines the geographic location of the social networking device 130 by timing signals received from GPS satellites to calculate distance from the social networking device 130 to each GPS satellite. Geometric trilateralation combines the calculated distances with the location of each GPS satellite to determine the geographic location of the social networking device 130. The social networking system 110 may receive data describing the geographic location of the social networking device 130, allowing the social networking system 110 to store data identifying the geographic location of the social networking device 130 over time. For example, the geographic location of the social networking device 130 is communicated to the authentication system 135 to provide a third party with information identifying the location of the social networking device 130.

The audio system 250 includes one or more speakers allowing a user to listen to audio output from the social networking device 130. In one embodiment, the audio system 250 also includes an audio jack that may be coupled to earphones, external speakers or another audio playback device to enable a user to listen to audio output from various devices. For example, earphones may be coupled to the audio jack to allow a user to listen to audio output without disturbing people around the user or to allow a user to hear the audio output in stereo or full three-dimensional audio that is enhanced with spatial characteristics. The audio system 250 may also include one or more microphones, allowing the social networking device 130 to capture audio data. Hence, the audio system 250 allows a user to receive data from the social networking device 130 using a first type of output modality by listening to audio data.

The pressure sensor array 260 includes one or more pressure-sensitive switches that generate an electrical signal when pressure is applied to the switches. For example, as a user squeezes the social networking device 130, the user depresses one or more switches in the pressure sensor array 260, generating an electrical signal that initiates an action by the processor 210. In one embodiment, the switches in the pressure sensor array 260 are located on different surfaces of the social networking device 130, allowing initiation of a different action when different switches are activated. For example, if a pressure-sensitive switch located on a first surface of the social networking device 130 is activated, the processor 210 initiates transmission of a gift to the social networking system 110 or to another social networking device 130 using the transceiver 290, while if a pressure-sensitive switch location on a second surface of the social networking device 130 is activated, the processor 210 initiates transmission of an emoticon to the social networking system 110 or to another social networking device 130.

The display device 270 may comprise any suitable display system for providing visual feedback, such as an organic light emitting diode (OLED) display, allowing the social networking device 130 to provide output using a second output modality by visually displaying information. In one embodiment, the display device 270 may comprise a touch-sensitive display including a digitizer for receiving input data, commands or information from a user. For example, the display device 270 is a capacitive touchscreen or another configuration where the position of an object relative to the display device 270 affects a value, allowing the positioning of an object relative to the display device 270 to provide data. The display device 270 displays data received from the social networking system 110 or from another social networking device 130. For example, the display device 270 may display graphics such as emoticons or images representing data received from another social networking device 130 or from a social network user.

The vibrotactile generator 280 comprises one or more devices configured to produce vibrational, tactile or other haptic feedback to a user of the social networking device 130. For example, the vibrotactile generator 280 vibrates one or more surfaces of the social networking device 130 when the social networking device 130 determines that data received by the transceiver 290 is associated with a gift or emoticon. The vibrotactile generator 280 may also generate tactile feedback when data representing a gift is transmitted from the social networking device 130 using the transceiver 290 and/or when a user interacts with the input device 230. In one embodiment, the vibrotactile generator 280 also includes an accelerometer which receives input based on movement of the social networking device 130. For example, shaking the social networking device 130 may allow a user to navigate between various menus or other items presented on the display device 270 or to initiate various types of actions using the social network. Further, the vibrotactile generator 280 may also increase the temperature of a surface of the social networking device 130 when one or more actions occur. For example, when an emoticon representing happiness or satisfaction is transmitted or received, the vibrotactile generator 280 increases the temperature of a surface of the social networking device 130 to provide a warm sensation to a user. Like the display device 270 and audio system 250, the vibrotactile generator 280 provides an additional output modality, haptic feedback, for presenting data to a user.

The transceiver 290 comprises a wireless communication device allowing wireless communication with the network 120 (e.g., via Bluetooth, WiFi, RF, infrared, 3G or ultrasonic). For example, the transceiver 290 identifies and communicates with one or more wireless access points using WiFi or identifies and communicates with one or more cell towers using RF. Additionally, the transceiver 290 may establish a communication channel between different social networking devices 130 allowing data to be directly communicated between social networking devices 130. For example, the transceiver 290 establishes a Bluetooth connection between different social networking devices 130. In an embodiment, the transceiver 290 also includes a jack for receiving a data cable (e.g., Mini-USB or Micro-USB), allowing use of a wired connection to communicate and receive data.

### Operation of the Social Networking Device

FIG. 3 is an event diagram of one embodiment of a method 300 for performing an action between social network users associated with two social networking devices 130A, 130B. Initially, a first social networking device 130A receives 310 an input requesting execution of an action. For example, the first social networking device 130A receives 310 a request to establish a connection with a user associated with a second social networking device 130B. The input may be received 310 using various formats. For example, an input device 230, a switch in the pressure sensor array 260 or an accelerometer in the vibrotactile generator 280 receives 310 an input requesting generation of a connection between two social network users or communication of data from the first user to the second user. After receiving 310 the input, the first social networking device 130A and the second social networking device 130B are positioned 320 physically proximate to each other. In one embodiment, a surface of the first social networking device 130A physically contacts a surface of the second social networking device 130B. Alternatively, the first social networking device 130A and the second social networking device 130B are positioned within a specified distance from each other.

When the first social networking device 130A and the second social networking device 130B are positioned 320 proximate to each other, the first social networking device 130A transmits 325 a first identifier to the second social networking device 130B using a transceiver 290 in the first social networking device 130A. The second social networking device 130B then stores 340 the received first identifier in a storage device 220. Similarly, the second social networking device 130B transmits 330 a second identifier to the first social networking device 130B using a transceiver 290 in the second social networking device 130B. The first social networking device 130A then stores 335 the second identifier in a storage device 220. For example, when the first social networking device 130A physically contacts the second social networking device 130B, the first social networking device 130A uses a Bluetooth or RF communication channel to transmit 325 a first 80-bit or 60-bit identification key associated with the first social networking device 130A to the second social networking device 130B. The second social networking device 130B similarly transmits 330 a second 80-bit or 60-bit identification key associated with the second social networking device 130A to the first social networking device 130A using the Bluetooth or RF communication channel.

After storing 335 the second identifier, the first social networking device 130A transmits 345 to the social networking system 110 an action request including a description of the action, the first identifier and the second identifier. For example, the first social networking device 130A transmits 345 an action request to generate a connection with a user associated with a second social networking device 130B and identifying the first social networking device 130A and the second social networking device 130B. The social networking system 110 directs the action request to the authentication system 115, where a third-party reviews the action request and determines whether to authenticate 350 the action. In one embodiment, the authentication system 115 determines a social network user associated with the second identifier and the third-party determines whether to authenticate 350 the requested connection based on information about the social network user associated with the second identifier. For example, the third-party reviews a social network profile associated with the social network user associated with the second identifier and determines whether to authenticate 350 the action based on the profile information. Alternatively, the authentication system 115 may determine whether the social network user associated with the second identifier meets certain criteria and authenticates 350 the requested connection based on the presence or absence of the criteria within a profile associated with the social network user associated with the second identifier. For example, the authentication system 115 authenticates 350 a connection based on the first identifier and the second identifier by determining whether age information in a profile associated with a social network user associated with the second identifier is within a specified range.

If the authentication system 115 authenticates 350 the requested connection, the social networking system 110 executes 355 the requested action and stores data indicating execution of the action between the social networking user associated with the first identifier and the social networking user associated with the second identifier. However, if the authentication system 115 does not authenticate 350 the requested connection, the data including the first identifier and the second identifier is deleted from the social networking system 110 without the action being executed 355. Hence, the authentication system 115 allows a third-party to review potential actions involving a social network user and determine whether a potential action is desirable for the social network users before the social networking system 110 executes 355 and stores the action.

In addition to reducing the likelihood of establishing a harmful connection, the authentication system 115 allows a third-party to be informed of connections, or other actions, performed by users of the social networking system 110. For example, the authentication system 115 notifies a parent of connection requests involving a child and allows the parent to determine whether a connection request is appropriate for the child. This allows a parent to prevent their child from establishing connections with potentially dangerous users of the social network. In addition to the authentication system 115, acquiring data from a social networking device 130 physically proximate to a social networking device 130 of a user incorporates a physical interaction into social network use, providing additional information about who a user is interacting with through the social network.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A social networking device for performing actions using a social network comprising:
a location determination device configured to determine a location of the social networking device relative to one or more other social networking devices;
a transceiver configured to transmit data from the storage device and receive data from one or more data sources;
an input device configured to receive input identifying an action;
a processor coupled to the location determination device, the transceiver and the input device; and
computer program code stored on a memory and configured to be executed by the processor, the computer program code including instructions for:
receiving an input identifying the action from the input device;
responsive to determining the social networking device is physically proximate to a second social networking device, transmitting the first identifier to the second social networking device and receiving a second identifier from the social networking device;
transmitting the first identifier, the second identifier and data identifying the action to a social networking system which authenticates the action based on data associated with the second identifier.

2. The social networking device of claim 1, wherein determining the social networking device is physically proximate to the second social networking device comprises:
determining a surface of the social networking device is physically contacting a surface of the second social networking device.

3. The social networking device of claim 1, wherein determining the social networking device is physically proximate to the second social networking device comprises:
determining the social networking device is within a specified distance of the second social networking device.

4. The social networking device of claim 1, further comprising:
an audio device configured to play audio data responsive to the action; and
a display device configured to present visual data associated with the action or visual data identifying one or more actions.

5. The social networking device of claim 4, further comprising
a vibrotactile generator configured to generate haptic feedback responsive to the action.

6. The social networking device of claim 5, wherein the vibrotactile generator includes:
an accelerometer configured to determine movement of the social networking device and generate an input responsive to the movement.

7. The social networking device of claim 1, further comprising:
one or more pressure sensitive switches configured to generate one or more inputs responsive to being depressed.

8. The social networking device of claim 7, wherein:
a first pressure sensitive switch is located on a first surface of the social networking device and is configured to generate data identifying a first action when depressed; and
a second pressure sensitive switch is located on a second surface of the social networking device and is configured to generate data identifying a first action when depressed.

9. The social networking device of claim 1, wherein the input device comprises a capacitive touch sensing pad.

10. The multi-channel portable interaction module of claim 1, wherein the action comprises a connection between a first user associated with the first identifier and a second user associated with the second identifier.

11. A system for social networking comprising:
a social networking device configured to receive an identifier associated with a second social networking device responsive to determining the social networking device is physically proximate to the second social networking device and to receive an input associated with an action, the social networking device also configured to generate an action request identifying the action, an identifier associated with the social networking device and the identifier associated with the second social networking device; and
a social networking system coupled to the social networking device, the social networking system configured to receive the action request, identify a first user associated with the identifier associated with the social networking device, identify a second user associated with the identifier associated with the social networking device, and receive an authentication permitting execution of the action based on data associated with the second user.

12. The system of claim 11, wherein the social networking device is configured to:
identify the action, the first user and the second user to a third-party; and
receive the authentication from the third-party.

13. The system of claim 11, wherein the data associated with the second user comprises a social network profile associated with the second user.

14. The system of claim 11, wherein determining the social networking device is physically proximate to the second social networking device comprises:
determining a surface of the social networking device is physically contacting a surface of the second social networking device.

15. The system of claim 11, wherein determining the social networking device is physically proximate to the second social networking device comprises:
determining the social networking device is within a specified distance of the second social networking device.

16. A computer-implemented method for performing an action in a social networking comprising:
receiving, by a social networking device, an input identifying the action;
responsive to determining the social networking device is physically proximate to a second social networking device, transmitting a first identifier included in the social network and uniquely identifying the social networking device to the second social networking device;
receiving a second identifier from the second social networking device, the second identifier uniquely identifying the second social networking device;
transmitting an action request including the first identifier, the second identifier and data identifying the action to a social networking system which authenticates the action based on data associated with the second identifier.

17. The method of claim 16, wherein determining the social networking device is physically proximate to the second social networking device comprises:
determining a surface of the social networking device is physically contacting a surface of the second social networking device.

18. The method of claim 16, wherein social networking device of claim 1, wherein determining the social networking device is physically proximate to the second social networking device comprises:
determining the social networking device is within a specified distance of the second social networking device.

19. The method of claim 16, wherein the first identifier and the second identifier comprises 64-bit identification keys.
